(19) United States
(12) Patent Application Publication
(10) Pub. No.: US 2012/0206365 A1
(43) Pub. Date: Aug. 16, 2012

(54) Method and System for Controlling a Computer with a Mobile Device

(76) Inventor: Eryk Wangsness, Mankato, MN (US)

(21) Appl. No.: 13/024,793

(22) Filed: Feb. 10, 2011

(51) Int. Cl. G06F 3/02

(52) U.S. Cl. 345/169

(57) ABSTRACT

Methods and systems in accordance with the present invention allow connection of a cellular telephone or other mobile device to a computer or other receiving device with a processor and user interface and thus allow input of text into the computer via the keypad of the cellular telephone or other mobile device. Methods and systems in accordance with the present invention further allow input of abbreviations common to character limited messaging formats; for example text messaging, Twitter, and Facebook; and translate such abbreviations into the words or phrases they commonly represent.

This generally relates to typing and/or inputting text into a computer or other receiving device with a processor and user interface, and more specifically relates to inputting text via the keypad of a cellular telephone or other mobile device to a computer or other receiving device.

### BACKGROUND

The 21^{st} century has seen a rise in cellular telephone usage, including a rise in the number of people who communicate via cellular telephone text messaging and/or other character limited formats such as Twitter and Facebook, browse the internet and input text via their cellular telephone, or otherwise input text via their cellular telephone keypad. Concurrently, young people as a group have grown less likely to develop their typing skills on a conventional, regular sized, “QWERTY” keyboard, and many of them are more comfortable and proficient at inputting text via their cellular telephone keypad.

Conventional cellular telephone keypads may have several different layouts. Some keypads are numerical keypads, alphabetically arranged with 3-4 letters corresponding to the numbers 2-9, such as the keypad on a conventional hardwired telephone. Many smart phones use miniature versions of a full QWERTY keyboard, either displayed on a touch screen, such as that on the iPhone by Apple, Inc., or contained on the phone, such as those on phones with a slide out keypad feature such as the Droid, by Motorola, Inc. However, even on cellular telephones with miniature QWERTY keypads, the size of the keypad dictates that users normally do not type using the conventional “home row” typing style associated with conventional, regular sized, QWERTY keyboards. Instead, these users often type exclusively with their thumbs in a style quite distinct from conventional home row typing, and because of their relative inexperience with home row typing, they are often more comfortable and proficient at inputting text via thumbs only typing on the cellular telephone keypad.

Further, the character limits of conventional text messages—160 characters in most platforms, Twitter posts—140 characters, Facebook posts—420 characters for a “status” post and 1000 characters for a message, and/or other character limited communication forms, as well as the desire for speed in communicating via these methods, have contributed to the adoption and regular use of a number of abbreviations in these formats, including many phoenetic abbreviations. For example, for English speakers, “gr8” may be substituted for “great,” “r” may be substituted for “are,” or “c u l8r” may be substituted for “see you later.” Such abbreviations are acceptable and understood for the often casual communications among relatives, friends, and acquaintances most associated with the use of text messaging, Twitter, Facebook or other character limited communication forms. However, some people are not familiar with these abbreviations, and have trouble deciphering the meaning of a message containing them. Further, in more formal typed communications, for example business letters and term papers, such abbreviations are frowned upon and should not be used.

Accordingly, there is a desire to avoid these and other related problems.

### SUMMARY

In accordance with the methods and systems consistent with the present invention, a method in a data processing system is provided for text typing on a computer via a mobile device, comprising receiving indications of typing of text on a keyboard on the mobile device, wherein the text includes one or more abbreviations of corresponding words, and converting the one or more abbreviations in the text to the corresponding words. The method further comprises sending the text to the computer, and displaying, by the computer, the text with the converted corresponding words replacing the one or more abbreviations of the corresponding words.

In one implementation, a data processing system is provided for text typing on a computer via a mobile device, comprising a mobile device comprising a keyboard. The mobile device is configured to receive indications of typing of text on the keyboard on the mobile device, wherein the text includes one or more abbreviations of corresponding words, convert the one or more abbreviations in the text to the corresponding words, and send the text to the computer. The computer is configured to display the text with the converted corresponding words replacing the one or more abbreviations of the corresponding words.

In another implementation, a data processing system is provided for text typing on a computer via a mobile device, comprising a mobile device comprising a keyboard. The mobile device is configured to receive indications of typing of text on the keyboard on the mobile device, wherein the text includes one or more abbreviations of corresponding words, and send the text to the computer. The computer is configured to convert the one or more abbreviations in the text to the corresponding words and display the text with the converted corresponding words replacing the one or more abbreviations of the corresponding words.

### BRIEF DESCRIPTION OF THE DRAWINGS

FIG. 1 illustrates a computer system consistent with methods and systems in accordance with the present invention.

FIG. 2 shows an exemplary embodiment of a cellular telephone or other mobile device connected to a computer or other receiving device with a processor and user interface in accordance with methods and systems consistent with the present invention.

FIG. 3 illustrates steps in a method for using a cellular telephone or other mobile device to input text into a computer or other receiving device with a processor and user interface in accordance with methods and systems consistent with the present invention.

### DETAILED DESCRIPTION

Methods and systems in accordance with the present invention allow connection of a cellular telephone or other mobile device to a computer or other receiving device with a processor and user interface and thus allow input of text into the computer via the keypad of the cellular telephone or other mobile device. Methods and systems in accordance with the present invention further allow input of abbreviations common to character limited messaging formats; for example text messaging, Twitter, and Facebook; and translate such abbreviations into the words or phrases they commonly represent.

In some implementations, the system may operate across a pluggable connector, for example a “mini-USB” connector such as those common to many cellular telephone charging devices. In this way, the cellular telephone or other mobile device may establish a mechanical connection to the computer or other receiving device with a processor and user interface when the mobile device is plugged in to the receiving device. In other implementations, the system may operate across a wireless connection, for example Bluetooth or Wifi, which is enabled to communicate with a software application running on the computer or other receiving device with a processor and user interface. In this way, the cellular telephone or other mobile device may establish a wireless connection to the computer or other receiving device with a processor and user interface whenever the wireless connector is enabled.

In some implementations, the system may include a method for translating common abbreviations used in character limited formats; for example text messaging, Twitter, and Facebook; into full words and/or phrases they are intended to represent. In some implementations, this method may be accomplished through a repository of common abbreviations used in character limited formats; for example text messaging, Twitter, and Facebook; coupled to the full words and/or phrases they are intended to represent. When the system recognizes one of the common abbreviations in the repository, it automatically replaces that abbreviation with the corresponding full word or phrase within the text.

In some implementations, the system may further enable the user to initiate printing of a document or text field housed on the recipient computer from the source mobile device.

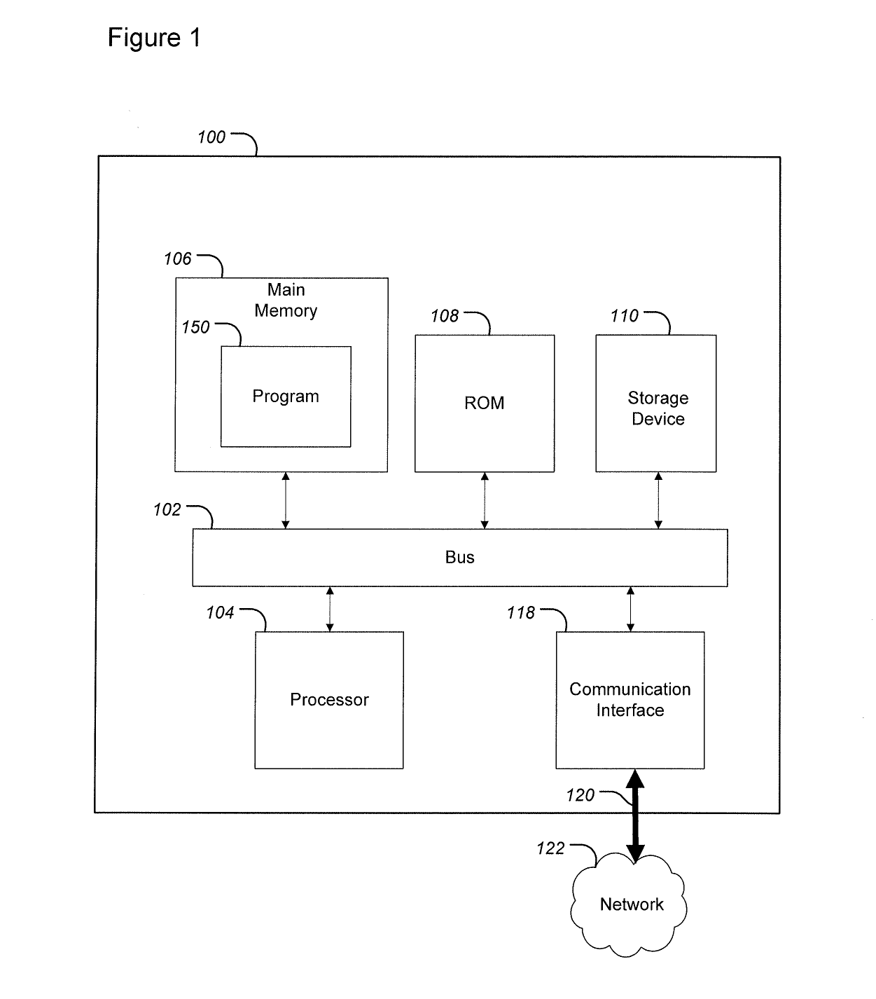

FIG. 1 illustrates an exemplary computer system 100 consistent with methods and systems in accordance with the present invention. Computer system 100 includes a bus 102 or other communication mechanism for communicating information, and a processor 104 coupled with bus 102 for processing the information. Computer 100 also includes a main memory 106, such as a random access memory (RAM) or other dynamic storage device, coupled to bus 102 for storing information and instructions to be executed by processor 104. In addition, main memory 106 may be used for storing temporary variables or other intermediate information during execution of instructions to be executed by processor 104. Main memory 106 includes a program 150 for implementing the text input and translating system in accordance with methods and systems consistent with the present invention. In some implementations, program 150 may be contained on the computer or other receiving device with a processor and user interface. In other implementations, program 150 may be contained on the cellular telephone or other mobile device. In yet other implementations, program 150 may reside on both the computer and the mobile device. Computer 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions. The storage device and/or the main memory may store information to be uploaded and downloaded from the system.

According to some embodiments, processor 104 executes one or more sequences of one or more instructions contained in main memory 106. Such instructions may be read into main memory 106 from another computer-readable medium, such as storage device 110. Execution of the sequences of instructions in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions. Thus, embodiments are not limited to any specific combination of hardware circuitry and software.

Although described relative to main memory 106 and storage device 110, instructions and other aspects of methods and systems consistent with the present invention may reside on another computer-readable medium, such as a floppy disk, flexible disk, hard disk, magnetic tape, CD-ROM, magnetic, optical or physical medium, RAM, PROM, EPROM, FLASH-EPROM, any other memory chip or cartridge, or any other medium from which a computer can read, either now known or later discovered.

Computer 100 also includes a communication interface 118 coupled to bus 102. Communication interface 118 provides a two-way data communication coupling to a network link 120 that is connected to a network 122, such as the Internet or other computer network. Wireless links may also be implemented. Communication interface 118 may send and receive signals that carry digital data streams representing various types of information. The communication interface may also be a hardwire or Bluetooth connection to the mobile device used by the user.

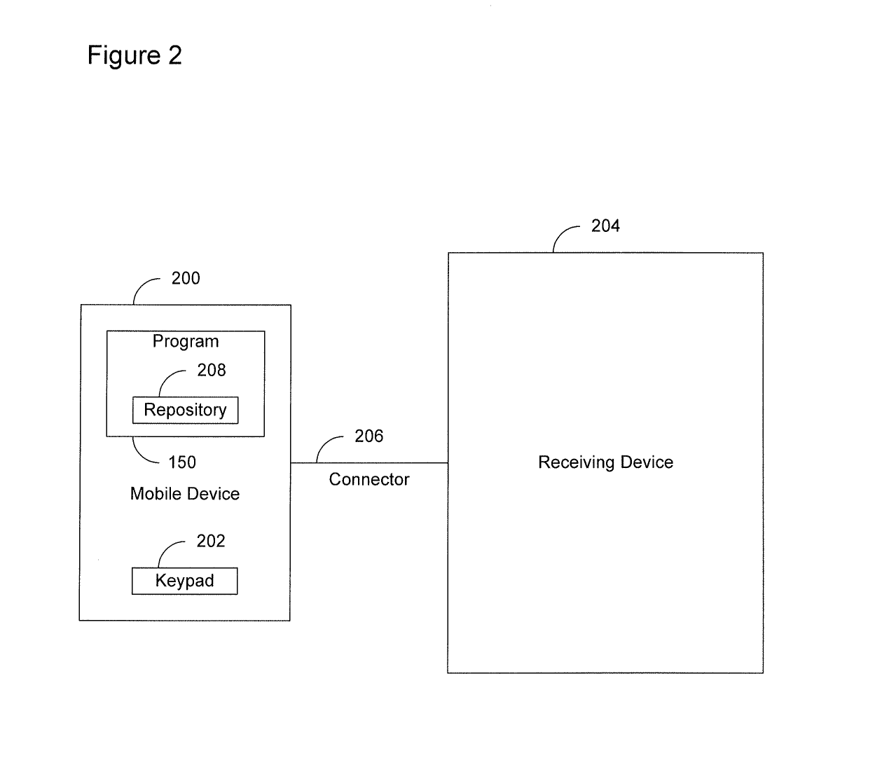

FIG. 2 shows an exemplary embodiment of a cellular telephone or other mobile device connected to a computer or other receiving device with a processor and user interface in accordance with methods and systems consistent with the present invention. Mobile Device 200 contains Keypad 202. In some implementations, Mobile Device 200 may be a cellular telephone. In other implementations, Mobile Device 200 may not be a cellular telephone, but may instead be any other suitable mobile device. Mobile Device 200 may be connected to Connector 204. In some implementations, Connector 204 is a physical connector, for example a “mini-USB” wire, and the connection between Mobile Device 200 and Connector 204 is a mechanical connection, for example Connector 204 is plugged into Mobile Device 200. In other implementations, Connector 204 is a wireless connector, for example a Bluetooth device or other Wifi connector, and the connection between Mobile Device 200 and Connector 204 is a wireless connection. Connector 204 may also be connected to Receiving Device 206. In some implementations, Receiving Device 206 may be a computer, such as Computer 100. In other implementations, Receiving Device 206 may be any other device with a processor and user interface, such as a laptop computer or tablet computer. In the implementations wherein Connector 204 is a physical connector, for example a “mini-USB” wire, Connector 204 is plugged into Receiving Device 206. In the implementations wherein Connector 204 is a wireless connector, the connection between Receiving Device 206 and Connector 204 is a wireless connection.

Further, in some implementations, the program may be enabled to translate common abbreviations used in character limited formats; for example text messaging, Twitter, and Facebook; into the full words and/or phrases they are intended to represent. Program 150 may contain Repository 208, a repository of common abbreviations used in character limited formats; for example text messaging, Twitter, and Facebook; coupled to the full words and/or phrases they are intended to represent. If Program 150 is active and the user inputs one of the common abbreviations contained in Repository 208, Program 150 automatically replaces the input abbreviation with the full word and/or phrase that abbreviation is intended to represent within the text field the user is entering text into on Receiving Device 206. In this way, the user is enabled to input text using common abbreviations into more formal documents, for example business letters or term papers, wherein the use of such abbreviations is frowned upon, thereby maintaining the user's normal typing conventions and their time saving benefits while simultaneously composing an appropriately formal text block.

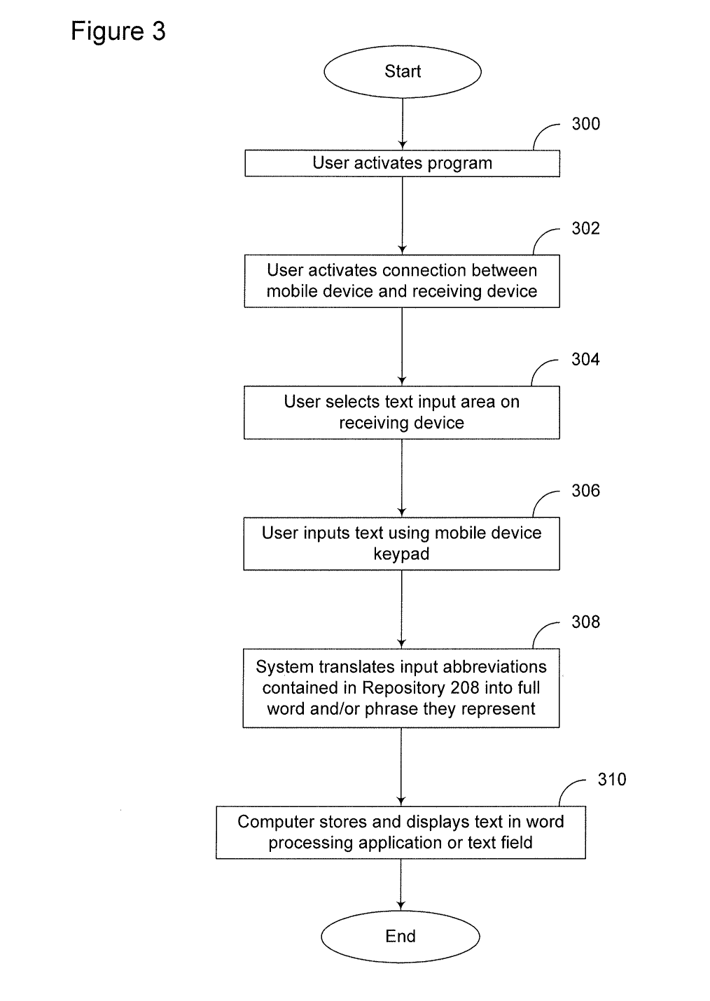

FIG. 3 illustrates steps in a method for using a cellular telephone or other mobile device to input text into a computer or other receiving device with a processor and user interface in accordance with methods and systems consistent with the present invention. Program 150 may be used to implement the text input and translation system in accordance with methods and systems consistent with the present invention. In some implementations, Program 150 may be contained on Mobile Device 200. In other implementations, Program 150 may be contained on Receiving Device 206. In yet other implementations, Program 150 may reside on both Mobile Device 200 and Receiving Device 206. First, the user activates Program 150 (step 300). Next, Mobile Device 200 and Receiving Device 206 are connected via Connector 204 (step 302). In some implementations, Connector 204 may be a physical connection embodied in a connecting device, for example a “mini-USB” connection, which may be activated by plugging the connecting device into both the cellular telephone or other mobile device and the computer or other receiving device with a processor and user interface. In other implementations this may be a wireless connection, for example Bluetooth or Wifi, which may be activated automatically upon detection by the computer. It should be understood that step 300 and step 302 may be completed in any order. Once Program 150 is active and Mobile Device 200 and Receiving Device 206 are connected via Connector 204, the user may select any text input area appearing on Receiving Device 206, for example a word processing document, such as a Microsoft Word document, or a text field on a website (step 304). This alerts the program that the user wishes to insert text into that area. Once a text input area on Receiving Device 206 is selected, the user may input text into that text area by typing on Keyboard 202, the mobile device's keypad (step 306). The system automatically inserts this text into the text input area on the receiving device selected in step 304. In some implementations, the system may store text typed into a mobile device, such as Mobile Device 200, which is not simultaneously connected to a computer or other device with a processor and user interface, such as Receiving Device 206. In these implementations, the transfer of the stored text to Receiving Device 206 may be initiated at a later time, once Mobile Device 200 is connected to Receiving Device 206 via Connector 204. If the user input text includes any of the abbreviations stored in Repository 208, the system may automatically replace the input abbreviation with the full word and/or phrase that abbreviation is intended to represent (step 308). Finally, the system causes the computer to store and display the text, for example in a word processing application such as Microsoft Word (step 310). In some implementations, the system may further enable a user to initiate printing of the entered text on the receiving computer from the mobile device.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for text typing on a computer via a mobile device, comprising:
receiving indications of typing of text on a keyboard on the mobile device, wherein the text includes one or more abbreviations of corresponding words;
converting the one or more abbreviations in the text to the corresponding words;
sending the text to the computer; and
displaying, by the computer, the text with the converted corresponding words replacing the one or more abbreviations of the corresponding words.

2. The method of claim 1, wherein the displaying further comprises displaying the converted text using a word processing program on the computer.

3. The method of claim 1, wherein the computer is one of: (1) a desktop computer, (2) a laptop computer, and (3) a tablet computer.

5. The method of claim 1, wherein the mobile device is a cellular phone.

6. The method of claim 1, further comprising typing, by a user with the user's thumbs, on the keyboard of the mobile device.

7. The method of claim 1, wherein the mobile device sends the text over a wireless connection.

8. The method of claim 7, wherein the wireless connection is one of: (1) Wifi and (2) Bluetooth.

9. The method of claim 1, wherein the keyboard comprises a virtual keyboard displayed on a screen.

10. A data processing system for text typing on a computer via a mobile device, comprising:
a mobile device comprising a keyboard, and configured to:
receive indications of typing of text on the keyboard on the mobile device, wherein the text includes one or more abbreviations of corresponding words;
convert the one or more abbreviations in the text to the corresponding words; and send the text to the computer; and
a computer is configured to display the text with the converted corresponding words replacing the one or more abbreviations of the corresponding words.

11. The data processing system of claim 1, wherein the display further comprises a word processing program configured to display converted text on the computer.

12. The data processing system of claim 1, wherein the computer is one of: (1) a desktop computer, (2) a laptop computer, and (3) a tablet computer.

13. The data processing system of claim 1, wherein the mobile device is a cellular phone.

14. The data processing system of claim 1, wherein the keyboard is configured to be typed on by a user with the user's thumbs.

15. The data processing system of claim 1, wherein the mobile device sends the text over a wireless connection.

16. The data processing system of claim 15, wherein the wireless connection is one of: (1) Wifi and (2) Bluetooth.

17. The data processing system of claim 1, wherein the keyboard comprises a virtual keyboard displayed on a screen.

18. A data processing system for text typing on a computer via a mobile device, comprising:
a mobile device comprising a keyboard, and configured to:
receive indications of typing of text on the keyboard on the mobile device, wherein the text includes one or more abbreviations of corresponding words;
and send the text to the computer; and
a computer configured to:
convert the one or more abbreviations in the text to the corresponding words;
display the text with the converted corresponding words replacing the one or more abbreviations of the corresponding words.
